(19) United States
(12) Patent Application Publication
(10) Pub. No.: US 2022/0105798 A1
(43) Pub. Date: Apr. 7, 2022

(54) LINE SYSTEM, FILLING ASSEMBLY INCLUDING A LINE SYSTEM AND METHOD FOR PRODUCING A LINE SYSTEM

(71) Applicant: Röchling Automotive SE & Co. KG, Mannheim (DE)

(72) Inventors: Andrea Valenari, Montagna (IT); Enrico Collatuzzo, Laives (IT)

(73) Assignee: Röchling Automotive SE & Co. KG

(21) Appl. No.: 17/491,710

(22) Filed: Oct. 1, 2021

(30) Foreign Application Priority Data
Oct. 5, 2020 (DE) 10 2020 126 002.4

(51) Int. Cl. B60K 15/04; B29C 49/00

(52) U.S. Cl. CPC B60K 15/04; B29C 49/0015; B29L 2023/005; B60K 2015/0467; B60K 2015/0474; B60K 2015/047

(57) ABSTRACT

A line system for connecting a liquid intake assembly to a liquid tank including a first fluid line for conducting a first fluid, a second fluid line for conducting a second fluid, the first and the second fluid lines being connected in an area between their respective first and second end by a connecting structure extending between the first and the second fluid lines, the connecting structure being integrally connected both with the first as well as with the second fluid line, at least one section of the first fluid line and one section of the second fluid line being arranged fluidically in parallel to each other, and the connecting structure having a fastening formation embodied in one piece with the first fluid line and a counterpart fastening formation embodied physically separately from the fastening formation and in one piece with the second fluid line.

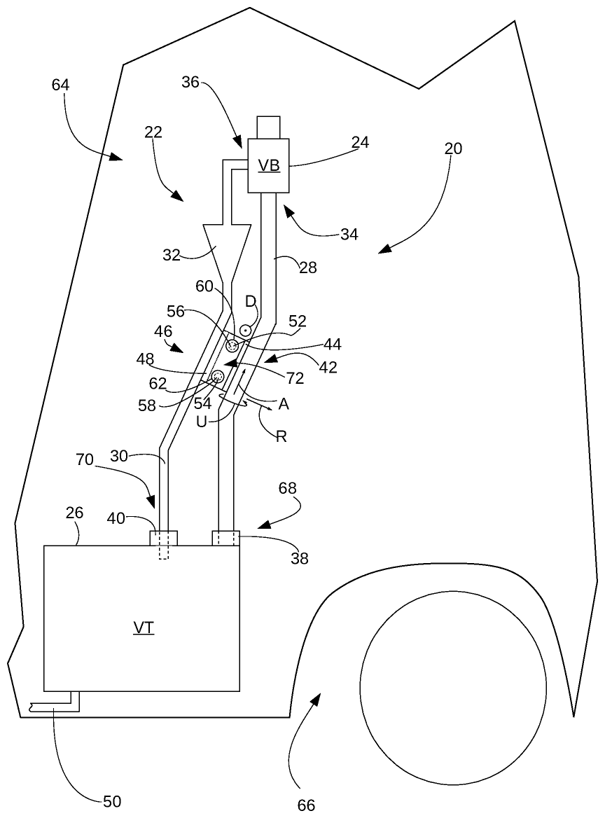

This Application claims priority in German Patent Application DE 10 2020 126 002.4 filed on Oct. 05, 2020, which is incorporated by reference herein.

The present invention relates to a line system for connecting a liquid intake assembly, preferably embodied as a filling head, to a liquid tank, comprising:
a first fluid line extending along a first line path for conducting a first fluid between its first end, which in operation is located closer to the liquid intake assembly, and its second end, which in operation is located closer to the liquid tank,
a second fluid line extending at a distance orthogonal to the first line path along a second line path for conducting a second fluid between its first end, which in operation is located closer to the liquid intake assembly, and its second end, which in operation is located closer to the liquid tank,
   wherein the first fluid line and the second fluid line are connected in an area between their respective first end and second end by a connecting structure extending between the first fluid line and the second fluid line, the connecting structure being integrally connected both to the first fluid line as well as to the second fluid line, at least one section of the first fluid line and a section of the second fluid line, in particular the entire first fluid line and the entire second fluid line, being arranged fluidically in parallel to each other.

### BACKGROUND OF THE INVENTION

Such a line system is described in the printed publication EP 0 636 505 B1. In this instance, as preferably also in the present invention, the first fluid line is a filling line for filling a tank with a liquid. The second fluid line is preferably a vent line for venting the tank while it is being filled, since the liquid flowing into the tank displaces air from the tank. The first fluid line as the filling line and the second fluid line as the vent line are embodied in one piece and in particular rigidly connected in one piece by the connecting structure. As a result, the known line system is rigid, which may make its installation difficult.

An aforementioned liquid intake assembly may be a filling head, as it is known from the printed publication DE 10 2015 217 599 A1. The liquid tank may be a tank, as it is known for example from the printed publication DE 10 2016 202 310 A1.

### SUMMARY OF THE INVENTION

It is an objective of the present invention to provide a line system that is easy to install as well as a filling assembly having this line system and a method for producing such a line system.

According to the present invention, this objective is achieved by a line system of the kind mentioned at the outset, in which the connecting structure comprises a fastening formation embodied in one piece with the first fluid line, and a counterpart fastening formation embodied physically separately from the fastening formation and in one piece with the second fluid line, the fastening formation being joined to the counterpart fastening formation in a joining area.

The design of the fastening formation as physically separate from the counterpart fastening formation makes it possible for the line system to be installed in a motor vehicle in a particularly simple manner prior to connecting the fastening formation and the counterpart fastening formation to each other. An installer is thus able to choose the time most suitable for him to connect the first fluid line and the second fluid line to each other. The installer may also keep the two fluid lines disconnected, if this seems advantageous. As long as the first and the second fluid lines are not connected to each other by the connecting structure, each fluid line is movable and deformable without influence from the other fluid line.

Since furthermore the individual fluid lines are embodied in one piece with the fastening formation and counterpart fastening formation, respectively, these formations are firmly and in a loss-proof manner connected to their respective fluid lines. The first line path and the second line path are to be understood respectively as virtual line paths extending centrally through their associated fluid lines.

The first fluid line and/or the second fluid line and/or the line system are/is preferably formed from a thermoplast-based plastic material or a thermoplastic. The thermoplastics mentioned here as such or as the basis of a plastic material may be polyamides, although preferably these thermoplastics are thermoplastic elastomers, particularly preferably thermoplastic vulcanizates or cross-linked thermoplastic elastomers, it also being possible to refer to the two latter thermoplastics using the abbreviation TPV.

Although one fluid of the first fluid and second fluid is preferably a liquid and the respectively other fluid is a gas, in particular air, in the operation of the line system in the vehicle, both liquid as well as gas will flow in both fluid lines due to the turbulences of the liquid when filling the tank. In the fluid line that preferably serves as the filling line, the proportion of liquid in the fluid flowing therein will predominate, while in the respectively other fluid line as a vent line, the proportion of gas in the fluid flowing therein will predominate. At least during a filling process, the fluids in the first fluid line and in the second fluid line will flow in opposite directions, that is, in one line from the first to the second end and the respectively other line from the second to the first end. In order to allow simultaneously for different fluid flows in the first fluid line and in the second fluid line with respect to flow quantity and/or flow direction, the first fluid line and the second fluid line are arranged fluidically in parallel to each other at least in sections, preferably entirely.

In the first line fastening section, the first fluid preferably flows along a first fluid path and in the second line fastening section, the second fluid preferably flows along a second fluid path, the first fluid path and/or the second fluid path preferably not penetrating a connecting area, in which the fastening formation overlaps with the counterpart fastening formation and/or in which the fastening formation abuts against the counterpart fastening formation. In particular, the fastening formation and/or the first line fastening section may be embodied at a distance from a first and/or a second end of the first fluid line, it being likewise possible for the counterpart fastening formation and/or the second line fastening section to be embodied at a distance from a first and/or second end of the second fluid line.

The first fluid line and the second fluid line are preferably connected to each other by a form-locking connection of the fastening formation and the counterpart fastening formation. For purposes of repair and maintenance, the form-locking connection is preferably detachable in a non-destructive manner. The connection may be produced by using a screw and/or a rivet and/or a fastening clip so that the first fluid line may be joined to the second fluid line in a particularly simple manner.

Alternatively, in order to obtain a particularly securely jointed and particularly stiff line system, it is possible to join the physically separate fastening formation and counterpart fastening formation in an integral manner, for example by ultrasonic welding or adhesive bonding, during or following the installation of the line system in the motor vehicle.

In a preferred specific embodiment of the form-locking connection, the fastening formation is connected to the counterpart fastening formation by using a, preferably non-destructively detachable, latching device. The latching device for this purpose may comprise a latching element, e.g. a latching protrusion, a spring clip, a fastening clip and/or a snap tab. The latching device may furthermore comprise a latching counterpart element, e.g. a latching recess and/or a through hole and or a rear-engagement edge. The latching element and the latching counterpart element are able to be brought into a, preferably detachable, latching engagement.

A latching element embodied in one piece with the fastening formation and/or a latching counterpart element embodied in one piece with the counterpart fastening formation have proved to be particular reliable and loss-proof.

If the latching element, e.g. a fastening clip, is embodied in a manner that is physically separate from the fastening formation and physically separate from the counterpart fastening formation, it does not interfere with the installation of the line system in the vehicle. It is then sufficient that the fastening formation and the counterpart fastening formation respectively comprise a latching counterpart element, e.g. a through hole. The latching counterpart element may be embodied on and/or in the fastening formation or the counterpart fastening formation, preferably respectively in and/or in one piece with a formation from the group of the fastening formation and the counterpart fastening formation.

In order to be able to use the area between the sections of the first and second fluid lines that are not joined to each other for positioning further components and component sections in a motor vehicle, at least one formation, preferably both formations, from the group of the fastening formation and the counterpart fastening formation preferably extend(s) over less than 50%, preferably over less than 20%, particularly preferably over less than 10% of the length of the longer of the first and second fluid lines.

A strengthening of the line system that reduces vibration noises and material fatigue is achieved in that at least one formation, preferably both formations, from the group of the fastening formation and the counterpart fastening formation is/are embodied in a rib-shaped or plate-shaped manner, a direction of thickness of the plate-shaped formation extending along a circumference, in particular in the circumferential direction of the fluid line, from which it sticks out. A formation counts as rib-shaped or plate-shaped if its dimension in the direction of thickness is significantly, in particular by a factor of 5, smaller than in its longitudinal direction and in its lateral direction.

The aforementioned objective is likewise achieved by a filling assembly, comprising a line system as described above, a liquid intake assembly preferably embodied as a filling head, and a liquid tank, at least one fluid line from the group of the first fluid line and the second fluid line, preferably both fluid lines, being fluidically connected to the liquid intake assembly at their first ends located closer to the liquid intake assembly and the first fluid line and the second fluid line being respectively fluidically connected to the liquid tank at their second ends located closer to the liquid tank. The advantages of the line system also apply to the filling assembly.

This objective is likewise achieved by a method for producing a line system as described above, comprising the steps: inserting a parison into a blow mold, in particular into a press blow mold, forming a first fluid line in one piece with a fastening formation in the blow mold from the parison in a blow molding process; forming a second fluid line in one piece with a counterpart fastening formation in the blow mold from the parison in the blow molding process, the counterpart fastening formation being formed physically separately from the fastening formation; removing the first fluid line and the second fluid line from the molds; and connecting the fastening formation and the counterpart fastening formation to each other, preferably at least one of the steps of the formation of the first fluid line and of the formation of the second fluid line comprising the use of a sizing unit for defining an inner diameter at least of a section of the first fluid line or of the second fluid line. The use of the sizing unit makes it possible to form in particular end sections of the first fluid line and the second fluid line with a defined inner diameter with great precision so that these end sections may be connected to a liquid intake assembly and/or to a quick coupling and/or a liquid tank in a particularly simple and fluid-tight manner.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWINGS

The invention may take physical form in certain parts and arrangement of parts, a preferred embodiment of which will be described in detail and illustrated in the accompanying drawing which forms a part hereof and wherein the invention is shown below on the basis of the enclosed schematic , which is not drawn to scale, which shows a filling assembly with a line system of the present invention arranged in a motor vehicle.

### DESCRIPTION OF PREFERRED EMBODIMENTS

Referring now to the drawing wherein the showings are for the purpose of illustrating preferred and alternative embodiments of the invention only and not for the purpose of limiting the same, the drawing shows a filling assembly 20, comprising a line system 22, which connects a liquid intake assembly in the form of a filling head 24 to a liquid tank 26. The liquid in liquid tank 26 may be output to a consumer via a line 50. Line system 22 comprises a first fluid line 28, which fluidically connects an internal volume VB of filling head 24 to an internal volume VT of liquid tank 26 and which is designed to conduct fluid filled into filling head 24, e.g. a liquid such as an aqueous urea solution, into liquid tank 26. Line system 22 further comprises a second fluid line 30 for venting the liquid tank 26, which fluidically connects the internal volume VB of filling head 24 to the internal volume VT of liquid tank 26. Second fluid line 30 comprises a equalizing reservoir 32, whose inner diameter is greater than an inner diameter of the second fluid line 30 over more than 50% of its extension outside of equalizing reservoir 32. Outside of equalizing reservoir 32, the inner diameter of second fluid line 30 is smaller than the inner diameter of first fluid line 28. If no equalizing reservoir 32 is provided, then what was said regarding the diameters of the first fluid line and the second fluid line applies in particular to their entire lengths.

First fluid line 28 and second fluid line 30 fluidically connect, respectively independently of each other, the internal volume VB of filling head 24 to the internal volume VT of liquid tank 26 and are thus arranged fluidically in parallel, even though sections of these fluid lines 28, 30 are not everywhere geometrically parallel to each other. A first end 34 of first fluid line 28 and a first end 36 of second fluid line 30 is respectively welded to filling head 24 to form a fluidic connection of the first and second fluid lines 28, 30 with filling head 24. At respective second ends 68, 70 of the first and second fluid lines 28, 30, first and second quick couplings 38, 40 are respectively embodied by a threaded fitting welded to the respective end, via which the respective first fluid line and second fluid line 28, 30 is fluidically connected to tank 26.

A first line fastening section 42 is embodied as a part of first fluid line 28 in one piece with a plate-shaped fastening formation 44, whose thickness extends in a direction of thickness D, which runs over a thickness extension of fastening formation 44 essentially along a circumference of first fluid line 28, here along a circumferential direction U of first fluid line 28. Fastening formation 44 is thus formed in one piece with first fluid line 28. Fastening formation 44 does not completely surround the internal volume of line fastening section 42 in circumferential direction U. A longitudinal extension of fastening formation 44 extends along an axial direction A of first fluid line 28 and/or a lateral extension of fastening formation 44 extends along a radial direction R of first fluid line 28. The longitudinal extension of fastening formation 44 is less than 50% of a length of the first fluid line 28.

A second line fastening section 46 is embodied as part of second fluid line 30 in one piece with a counterpart fastening formation 48. Counterpart fastening formation 48 is thus formed in one piece with second fluid line 30. Counterpart fastening formation 48 has a platelike shape, and what was said with regard to the thickness, longitudinal and lateral extension of fastening formation 44 with respect to first fluid line 28 applies analogously to the second fluid line 30 for these extensions of counterpart fastening formation 48. The longitudinal extension of counterpart fastening formation 48 is less than 50% of a length of the second fluid line 30. Fastening formation 44 and counterpart fastening formation 48 form a connecting structure.

Fastening formation 44 has through holes 52 and 54 and counterpart fastening formation 48 has through holes 56 and 58, through holes 52 to 58 being arranged in such a way and fastening formation 44 overlapping with counterpart fastening formation 48 in a connecting area 72 in such a way that through holes 52, 56 and 54, 58, are respectively aligned. The pair of through holes 52, 56 is penetrated by a fastening clip 60, which is non-destructively removable and is embodied physically separately from fastening formation 44 and counterpart fastening formation 48, and the pair of through holes 54, 58 is penetrated by a fastening clip 62, which is non-destructively removable and is embodied physically separately from fastening formation 44 and counterpart fastening formation 48, whereby fastening formation 44 is fastened on counterpart fastening formation 48, and thus first fluid line 28 is fastened on second fluid line 30 by a form-locking connection. Fastening clips 60, 62 respectively form a latching element and through holes 52 through 58 respectively form a latching counterpart element of a latching device.

On account of the physically separate embodiment of fastening formation 44 from counterpart fastening formation 48, first fluid line 28 may be provided as relatively movable with respect to second fluid line 30 during the installation on filling head 24. It is possible to fasten fastening formation 44 on counterpart fastening formation 48 only after filling head 24 has been installed in a vehicle 64, for example near a wheel well 66, and then fluidically to connect fluid lines 28, 30 with tank 26, for example via quick couplings 38, 40, thereby reducing the expenditure of time and costs for installing line system 22.

The line system 22 described above is embodied in that a parison made of TPV is inserted into a blow mold, in particular a press blow mold, and that the blow mold is closed after or at the same time as the parison is filled with a blow mold medium, as a result of which first fluid line 28 is formed in one piece with fastening formation 44 and second fluid line 30 is formed in one piece with counterpart fastening formation 48. Sliding and/or squeezing and/or separating tools may be provided in the blow mold, which separate the fastening formation from the counterpart fastening formation. After removing the first and second fluid lines 28, 30 from the mold, fastening clips are inserted into through holes 52 to 58, as described above, whereby the fastening formation is fastened to the counterpart fastening formation. This step may be performed before or after welding the respective first ends 34, 36 of the first and second fluid lines 28, 30 to a filling head 24. Furthermore, the method for producing line system 22 may comprise the embodying of a first and a second quick coupling 38, 40 at respective second ends 68, 70 of the first and second fluid lines, in particular by welding respectively one threaded fitting to a respective second end 68, 70 of the first and second fluid lines 28, 30 using a sonotrode.

In order to facilitate the connection of the respective fluid line 28, 30 to filling head 24 and/or to the respective threaded fitting, a sizing unit may be used in the method for producing the line system when forming the first and/or the second fluid line 28, 30, so that an inner diameter of the end sections of the first and second fluid lines 28, 30 is defined with a low tolerance for a blow molding method.

The printed publications DE 10 2015 217 599 A1 and DE 10 2016 202 310 A1 are herewith incorporated by reference into this application in their entirety along with the equivalent U.S. Pat. No. 10,655,521.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A line system for connecting a liquid intake assembly to a liquid tank, comprising:
a first fluid line extending along a first line path for conducting a first fluid between its first end, which in operation is located closer to the liquid intake assembly, and its second end, which in operation is located closer to the liquid tank,
a second fluid line extending at a distance orthogonal to the first line path along a second line path for conducting a second fluid between its first end, which in operation is located closer to the liquid intake assembly, and its second end, which in operation is located closer to the liquid tank,
the first and the second fluid lines, being connected in an area between their respective first and second ends by a connecting structure extending between the first and the second fluid line, the connecting structure being integrally connected both to the first as well as to the second fluid line,
at least one section of the first fluid line and one section of the second fluid line being arranged fluidically in parallel to each other,
wherein the connecting structure has a fastening formation embodied in one piece with the first fluid line, and a counterpart fastening formation embodied physically separately from the fastening formation and in one piece with the second fluid line, the fastening formation and the counterpart fastening formation being joined to each other in a joining area.

12. The line system as recited in claim 11, wherein the first fluid line is connected to the second fluid line by a form-locking connection of the fastening formation to the counterpart fastening formation.

13. The line system as recited in claim 12, wherein the fastening formation is connected to the counterpart fastening formation by using a latching device, the latching device comprising a latching element and a latching counterpart element.

14. The line system as recited in claim 13, wherein the latching element is embodied in one piece with the fastening formation.

15. The line system as recited in claim 13, wherein the latching element is embodied physically separately from the fastening formation and physically separately from the counterpart fastening formation, and the fastening formation and the counterpart fastening formation respectively comprise one latching counterpart element.

16. The line system as recited in claim 11, wherein the fastening formation extends over less than 50% of a length of the first fluid line in an axial direction of the first fluid line.

17. The line system as recited in claim 11, wherein at least one formation from the group of the fastening formation and the counterpart fastening formation has a plate-shaped design, a direction of thickness of the plate-shaped formation extending along a circumference of a fluid line from the group of the first fluid line and the second fluid line.

18. A filling assembly, comprising a line system as recited in claim 11, a liquid intake assembly and a liquid tank, at least one fluid line from the group of the first fluid line and the second fluid line being fluidically connected to the liquid intake assembly at their first ends located closer to the liquid intake assembly and the first fluid line and the second fluid line being fluidically connected to the liquid tank at their second ends located closer to the liquid tank.

19. A method for producing a line system as recited in claim 11, comprising the steps:
inserting a parison into a blow mold,
forming a first fluid line in one piece with a fastening formation in the blow mold from the parison in a blow molding process,
forming a second fluid line in one piece with a counterpart fastening formation in the blow mold from the parison in the blow molding process, the counterpart fastening formation being embodied physically separately from the fastening formation,
removing the first and the second fluid lines, from the mold, and
connecting the fastening formation and the counterpart fastening formation to each other.

20. The method as recited in claim 19, wherein at least one of the steps of forming the first fluid line and of forming the second fluid line comprises the use of a sizing unit for defining an inner diameter at least of a section of the first fluid line and of the second fluid line, respectively.
